(19) United States
(12) Patent Application Publication
(10) Pub. No.: US 2011/0299238 A1
(43) Pub. Date: Dec. 8, 2011

(54) AUDIO INPUT AND OUTPUT DOCK FOR A TABLET COMPUTER

(75) Inventors: Daniel I. Radin, Boston, MA (US); Brian R. Shim, Providence, RI (US)

(73) Assignee: ALESIS, L.P., Cumberland, RI (US)

(21) Appl. No.: 13/151,986

(22) Filed: Jun. 2, 2011

Related U.S. Application Data
(60) Provisional application No. 61/351,029, filed on Jun. 3, 2010.

(51) Int. Cl. G06F 1/16

(52) U.S. Cl. 361/679.41

(57) ABSTRACT

An audio input and output dock for a tablet computer is disclosed. The dock includes a housing having a cradle configured and arranged to receive a tablet computer docked therein. A number of audio output and input connectors are configured and arranged to connect to the tablet computer when docked in the cradle. The audio output and input connectors include professional grade audio output and input jacks that musicians highly desire.

### CROSS-REFERENCE TO RELATED APPLICATION

The present patent document claims priority to earlier filed U.S. Provisional Patent Application Ser. No. 61/351,029, filed on Jun. 3, 2010, the entire contents of which are incorporated herein by reference.

### BACKGROUND OF THE INVENTION

1. Field of the Invention

This patent document relates generally to electronic audio input and output devices and more specifically to a dock providing enhanced audio input and output capabilities to a tablet computer.

2. Background of the Related Art

Tablet computers, such as Apple's iPad, have a large touch screen interface, which has the capacity for allowing musicians to create new methods of creating music through touch and feel. However, tablet computers are limited in capabilities to create music because the devices are not equipped with electronics capable of recording and playing back high-quality audio. Furthermore, tablet computers often lack the proper type of connectors and interfaces commonly used in professional quality audio recording and playback devices. Accordingly, there is a perceived need in the industry for a device to permit a tablet computer to record and playback high-quality or professional grade audio.

### SUMMARY OF THE INVENTION

The present invention solves the problems of the prior art by providing an audio input and output (or “I/O”) dock for a table computing device. The audio I/O dock provides a means for recording and playing back high-quality audio to and from a tablet computer using industry-standard connectors that musicians have become accustomed to.

### BRIEF DESCRIPTION OF THE DRAWINGS

These and other features, aspects, and advantages of the present invention will become better understood with reference to the following description, appended claims, and accompanying drawings where:

FIG. 1 is a schematic diagram of a preferred embodiment of the audio I/O dock for a tablet computer;

FIG. 2 is a schematic diagram of an alternative embodiment of the audio I/O dock for a tablet computer;

FIG. 3 is a perspective view of the preferred embodiment of the audio I/O dock for a tablet computer, with the dock empty;

FIG. 4 is a is a perspective view of the preferred embodiment of the audio I/O dock for a tablet computer, with a tablet computer in the dock;

FIG. 5 is a rear elevation view of the preferred embodiment of the audio I/O dock for a tablet computer;

FIG. 6 is a right side elevation view of the preferred embodiment of the audio I/O dock for a tablet computer; and

FIG. 7 is a left side elevation view of the preferred embodiment of the audio I/O dock for a tablet computer.

### DESCRIPTION OF THE PREFERRED EMBODIMENTS

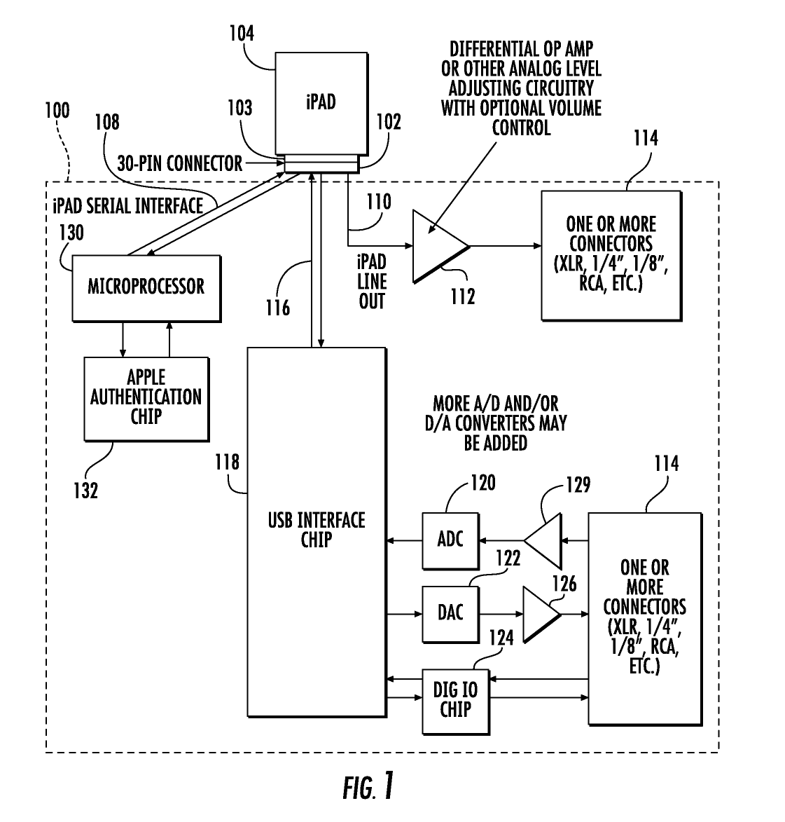

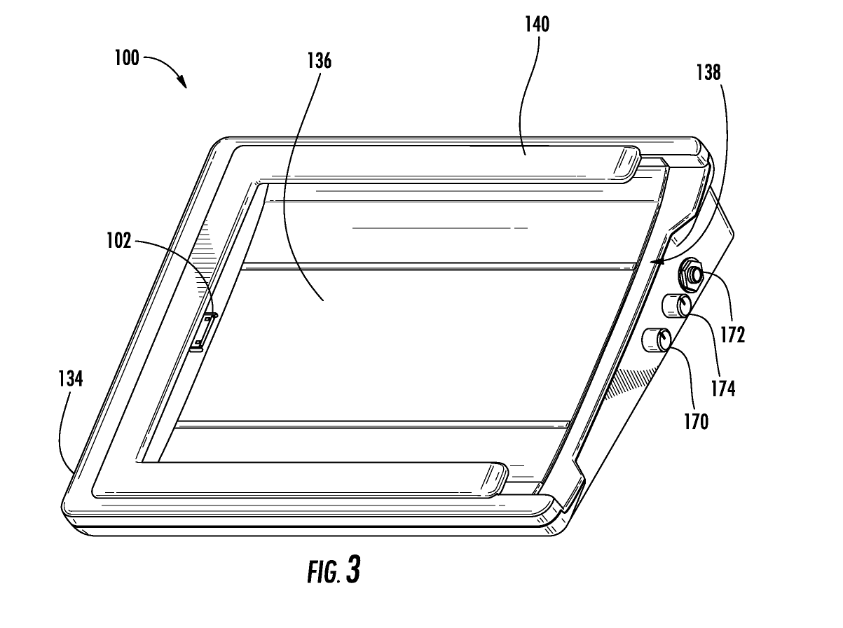

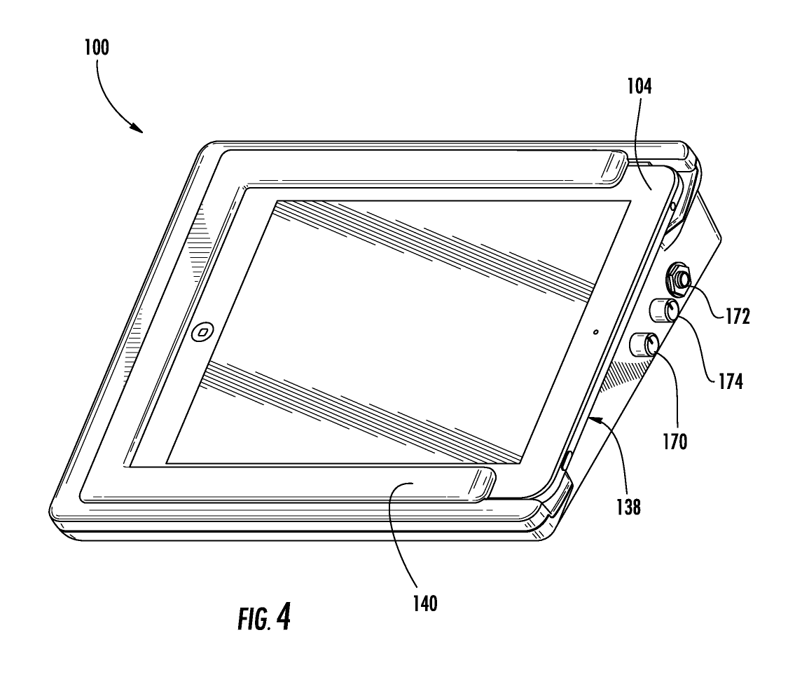

Referring now to FIGS. 1 and 3-7, the audio I/O dock of the present invention is shown generally at 100. The audio I/O dock 100 includes a connector 102 to attach to a tablet computer 104. In the case of an iPad brand tablet computer 104, the connection to the iPad is achieved through the iPad's 30-pin connector at the bottom of the iPad. The connecting the connector 102 on the audio I/O dock to a tablet computer's 104 connector can be achieved through a cable or a stationary dock-style connector. In the preferred embodiment shown in FIGS. 3-7, a stationary-style dock connector 102 is shown in a cradle 106 configured to securely hold the tablet computer 104 (best seen in FIGS. 3 and 4).

There are a variety of signals that are transmitted to and from the tablet computer 104 through the dock connector 102. One set of signals are the serial RX and TX signals 108. In the case of an iPad brand tablet computer, pins 18 and 19 of the iPad's 30-pin connector 103 are used for the serial RX and TX signals 108. These pins are used for serial communication with the iPad. The audio I/O dock 100 of the present invention uses the serial RX and TX signals 103 in order to authenticate the audio I/O dock 100 to the tablet computer 104, and to enable audio recording to the tablet computer 104.

The dock connector 104 further includes Line Out pins 110. In the case of an iPad brand computer, pins 27 and 28 of the iPad connector are used. Furthermore the Line Out pins 110 may be conditioned at 112 to the appropriate level for line or balanced output of audio. For instance a differential operational amplifier may be used. Other analog level adjusting circuitry may also be used to condition the Line Out pins 110. An optional volume control may be included at 112.

Industry-standard audio input and output connectors 114 are included on the audio I/O dock, such as microphones, ⅛″ cables, ¼″ cables, RCA cables, or XLR cables. One or more audio input and output connectors may be used.

Furthermore, audio input and output may be transmitted through the high-speed serial interface pins 116 of the dock connector 102. In the case of an iPad brand tablet computer, audio input and output may be provided through the iPad's universal serial bus port (pins 4 and 6). The pins 116 can be connected to a high speed interface controller 118, such as USB interface controller, in the audio I/O dock 100 of the present invention. The high-speed interface controller 118 is connected to one or more Audio to Digital Converters (ADCs) 120, Digital to Audio Converters (DACs) 122, or Digital Audio Input and Output controller 124 to convert to Sony/Philips Digital Interconnect Format (SPDIF), ADAT Optical, or other digital audio format.

The DACs 122 are connected to analog amplifiers or level shifting circuits 126 with or without gain control, then to an industry-standard audio jacks or connectors 114 (such as XLR, ¼″, ⅛″, RCA, etc.). The ADCs 120, and Digital Audio I/O 126 are connected to any of the industry-standard jacks 114 above or an optical connector 128 (such as ADAT optical or SPDIF optical).

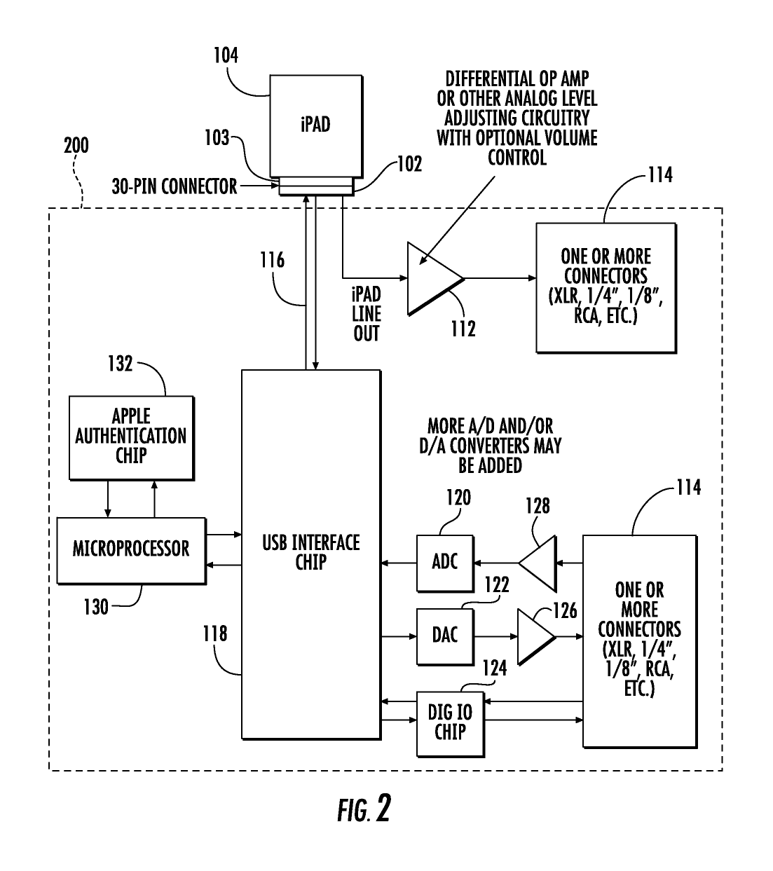

A microprocessor 130 for communicating with the tablet computer 104 is further provided. The microprocessor 130 may be connected directly through the serial interface 108 of the connector 102 to the tablet computer 104 (as in FIG. 1) or may also communicate through a high-speed serial controller 118, such as a USB interface controller, to the tablet computer 104, described further below (and as shown in FIG. 2).

An authentication chip 132 may also be provided, which is connected to the microprocessor 130. The authentication chip 132 ensures the tablet computer 104 is authorized to be attached to the audio I/O dock 100 of the present invention.

Referring to FIG. 2, authentication can also be achieved through high-speed serial communications, such as USB, instead of the tablet computer's serial interface 108, which is slower. Specifically the high speed serial controller 118 may be connected to a microprocessor 130 instead, which communicates with the authentication chip 132 and passes the authentication information to the tablet computer 102 via the high speed interface controller 118. In another embodiment, the high-speed interface controller 118 may be integrated into the microprocessor 130 in a single chip.

Power for the audio I/O dock 100 of the present invention can be provided by the onboard batteries of the tablet computer 104, by batteries installed in the audio I/O dock, or by a wall power supply as is known in the art.

Referring now to FIGS. 3 and 4, an exemplary audio I/O dock is shown generally at 100. The audio I/O dock 100 may include either implementation of the electrical operation as described above in FIGS. 1 and 2. The audio I/O dock 100 includes a wedge-shaped housing 134 with a cradle 136 formed in the top panel of the housing 134, which forms a well to receive and hold the tablet computer 104. The angle of the wedge-shaped housing 134 orients the tablet computer 104, when placed in the cradle, towards the musician. The cradle 136 includes an open end 138 where the tablet computer 104 is slid into the cradle 136. Although the open end 138 of the cradle 136 is facing to one side, the open end 138 could be oriented in another direction. A lip 140 around an edge of the cradle 136 prevents the table computer from dislodging from the cradle 136 in any direction other than the open end 138. The lip 140 extends over the cradle 136, and the front surface of the tablet computer 104 when placed in the cradle 136, but does not interfere with the touch screen of the tablet computer 104.

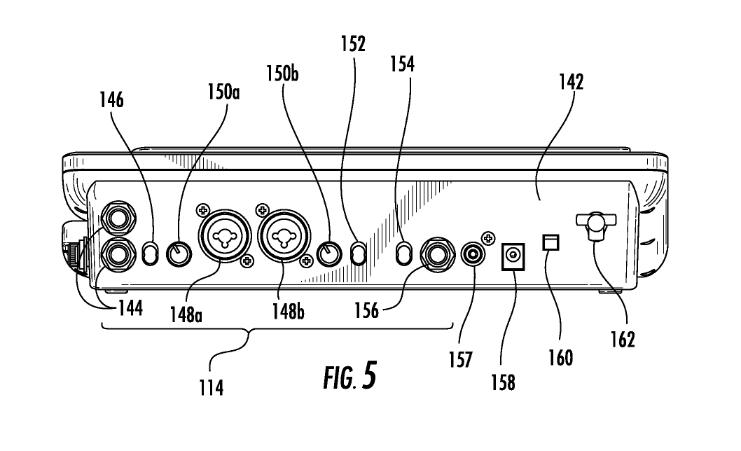

Referring now to FIG. 5, a rear panel 142 of the audio I/O dock is shown. The rear panel 142 includes many of the connectors 114 mentioned above. Working left to right in FIG. 5, two ¼″ jacks are provided for the audio main outputs 144, for left and right stereo audio, respectively. An optional direct monitoring toggle switch 146 may be provided to bypass the tablet computer 104 entirely so the musician can hear audio directly from the audio input and audio output connectors 114. Direct monitoring is useful if there is latency or delay in the tablet computer 104, which interferes with the musician's ability to synchronize instrument playing with audio playing from the tablet computer 104.

Two audio inputs with XLR connectors 148a, 148b are also provided. Each audio input 148a, 148b includes a separate gain control 150a, 150b. Furthermore, the second audio input 148b includes a guitar/microphone toggle switch 152 for use with amplifier and effects modeling applications.

A phantom power toggle switch 154 may also be provided for use with condenser microphones. Also included is an assignable ¼″ jack 156 for a footswitch. A video output connector 157 may also be provided to mirror the display of the tablet computer to a larger monitor or a projector. A power connector 158 and power switch 160 are also provided on the rear panel 142. An optional strain relief 162 may be provided for a power chord connected to the power connector 158.

Of course, these connectors 114 may easily be placed on another surface of the audio I/O dock of the present invention and be organized in a different manner. The exemplary embodiment is merely provided as one method of placing and organizing the different connectors that has been found to be desirable by musicians.

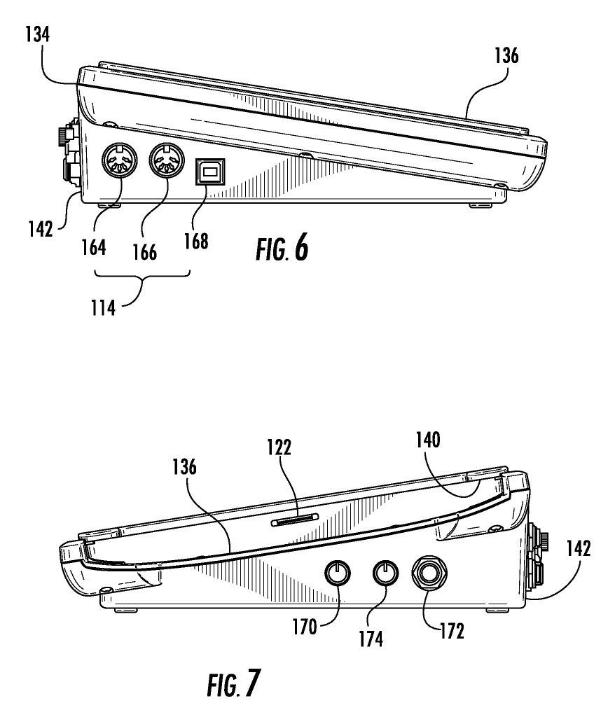

Referring now to FIG. 6, a right side elevation view of the preferred embodiment of the audio I/O dock is shown. A MIDI input and output DIN connectors 164, 166 are provided. Also included is a USB MIDI connector 168.

Referring now to FIG. 7, a left side elevation view of the preferred embodiment of the audio I/O dock is shown. A main volume knob 170 is provided. In addition, a ¼″ headphone jack 172 and headphone volume knob 174 may also be provided.

Therefore, it can be seen that the present invention provides a unique solution to the problem of providing a capability of recording and playing back high-quality audio to and from a tablet computer.

It would be appreciated by those skilled in the art that various changes and modifications can be made to the illustrated embodiments without departing from the spirit of the present invention. All such modifications and changes are intended to be within the scope of the present invention except insofar as limited by the appended claims.

We claim:

1. An audio input and output dock for a tablet computer, comprising:
a housing having a cradle configured and arranged to receive a tablet computer docked therein;
a plurality of audio output connectors and audio input connectors configured and arranged to connect to the tablet computer when docked in the cradle; and
said plurality of audio output connectors and audio input connectors consisting essentially of professional grade audio output jacks and audio input jacks, respectively.

2. The audio input and output dock of claim 1, wherein the housing is wedge-shaped.

3. The audio input and output dock of claim 1, wherein the cradle includes an open top face bound by a lip and an open end configured and arranged to have the tablet computer slid therethrough to dock in the cradle, whereby the lip curls over the tablet computer without interfering with the operation of a touch screen of the tablet computer.

4. The audio input and output dock of claim 1, wherein the professional grade audio output jacks and audio input jacks are selected from the group consisting essentially of ⅛″ jack, ¼″ jack, RCA jack, and XLR jack.

5. The audio input and output dock of claim 1, further comprising a high-speed interface controller connected to the plurality of audio input connectors and audio output connectors, the high-speed interface controller configured and arranged to communicate audio input to the tablet computer from the audio input jacks and audio output from the tablet computer to the audio output jacks.

6. The audio input and output dock of claim 1, further comprising a MIDI input.

7. The audio input and output dock of claim 1, further comprising a MIDI output.

8. The audio input and output dock of claim 1, further comprising a USB MIDI connector.

9. The audio input and output dock of claim 1, further comprising a footswitch connector.

10. The audio input and output dock of claim 1, further comprising a power connector configured and arranged to supply an external power to the audio input and output dock and tablet computer.

11. The audio input and output dock of claim 1, further configured and arranged to use power from a battery of the tablet computer.

12. The audio input and output dock of claim 1, wherein authentication is performed to the tablet computer via a slow serial interface.

13. The audio input and output dock of claim 1, wherein authentication is performed to the tablet computer via a high-speed interface controller.

14. The audio input and output dock of claim 1, wherein the plurality of audio output connectors and audio input connectors are connected to an analog line output of the tablet computer.
